(19) United States
(12) Patent Application Publication
(10) Pub. No.: US 2017/0282147 A1
(43) Pub. Date: Oct. 5, 2017

(54) NANOSTRUCTURED APPARATUS AND METHODS FOR PRODUCING CARBON-CONTAINING MOLECULES AS A RENEWABLE ENERGY RESOURCE

(71) Applicant: University of Massachusetts, Boston, MA (US)

(72) Inventors: Mengyan Shen, Belmont, MA (US); Cong Wang, Lowell, MA (US)

(73) Assignee: University of Massachusetts, Boston, MA (US)

(21) Appl. No.: 15/619,684

(22) Filed: Jun. 12, 2017

Related U.S. Application Data
(62) Division of application No. 13/280,401, filed on Oct. 25, 2011.
(60) Provisional application No. 61/406,270, filed on Oct. 25, 2010.

(51) Int. Cl. B01J 19/12; B01J 35/00; C01B 13/02; C01B 3/04; B01J 23/75; B82Y 40/00

(52) U.S. Cl. CPC B01J 19/127; Y02E 60/364; B01J 23/75; B01J 35/0013; Y02P 20/133; B82Y 40/00; C01B 3/042; C01B 13/0207

(57) ABSTRACT

Nanostructured arrays having a metal catalyst (e.g., cobalt) are irradiated with light to initiate the an artificial photosynthetic reaction resulting in the formation of carbon-containing molecules, for example, long chained hydrocarbons or amino acids. A nanostructure having one or more structural elements having a high aspect ratio can formed over a substrate and are placed in contact with water and a carbon-containing source (e.g., carbon dioxide, bicarbonate, methane). When the nanostructure is exposed to light, the water and the carbon-containing source can react to form a molecule having at least two carbon atoms chained together. Structural elements may include a number of metal layers arranged in a patterned configuration so that, upon light irradiation, a greater amount of light energy is concentrated in close proximity to the region where the reaction is catalyzed than for the case without the patterned configuration.

### RELATED APPLICATIONS

This application claims the benefit of U.S. Provisional Application No. 61/406,270, filed Oct. 25, 2010, which is hereby incorporated by reference in its entirety.

### BACKGROUND

### 1. Field of Invention

Aspects described herein relate to methods and apparatuses for producing carbon-containing molecules via artificial photosynthesis which can be used as a source of renewable energy. In some instances, a nanostructured apparatus may serve to initiate a reaction in the presence of water and a carbon-containing source to generate carbon molecule chains.

### 2. Related Art

Sunlight is a renewable and environmentally friendly energy source that many have looked to harness as a solution to global energy. If able to effectively convert and store solar energy on a large scale and at low cost, solar energy can be a viable source of alternative energy. There has been a significant amount of interest in replicating the natural process of photosynthesis. Researchers have endeavored to split water into hydrogen and oxygen to store solar energy by the photovoltaic effect and electrolysis. Researchers have also sought to convert carbon dioxide and water to carbohydrate and hydrocarbon compounds through charge transfer using photoexcited semiconductors for many years. Previously, an electric current has been run through TiO₂ nanotubes mixed with water and carbon dioxide to produce methane gas.

### SUMMARY

The inventors have recognized and appreciated that, under appropriate conditions, a nanostructured apparatus may be used to initiate a reaction involving water and a carbon-containing source resulting in the production of long-chained carbon molecules (e.g., hydrocarbons, amino acids, polymers), much akin to photosynthesis. As a result, the products generated by methods and apparatuses contemplated by the inventors may be a source of renewable energy which may further allow for more efficient utilization and conservation of existing energy resources. Essentially, fuel in the form of carbon-containing molecules having at least two carbon atoms chained together may be produced from exposing a suitable nanostructure to water, a carbon-containing source such as carbon dioxide and light (e.g., sunlight).

In some embodiments, when a nanostructured apparatus fabricated in accordance with manufacturing techniques discussed herein is exposed to light radiation in the presence of water and a carbon-containing source (e.g., carbon dioxide, methane, bicarbonate), a reaction takes place producing molecules having at least two carbon atoms chained together. Such a reaction may be catalyzed by the nanostructured apparatus where the only source of energy for driving the reaction is from the light radiation. In some cases, the nanostructured apparatus includes an array of structural elements having a high aspect ratio (e.g., nanospikes, nanoflakes) and incorporating a catalyzing material (e.g., cobalt, iron) that effectively lowers the free energy of reaction for single carbon molecules to chemically bond with other molecules under suitable conditions. Appropriate light energy for driving the artificial photosynthesis reaction may be provided from, for example, ambient light, sunlight, artificially generated light, or any other suitable source of electromagnetic radiation. Accordingly, methods of producing chained carbon molecules and the products themselves may be useful as a source of renewable energy.

A nanostructure may be fabricated and placed in conditions such that the nanostructure comes into contact with water and a carbon-containing source and, upon light irradiation, catalyzes a reaction between the water and the carbon-containing source. The reaction between the water and the carbon-containing source may involve chemical bonding of carbon atoms with other carbon atoms or other non-carbon atoms (e.g., nitrogen, oxygen) to form organic chains that can be used as sources of energy (e.g., combustible compounds). The nanostructure may include a number of structural elements attached to a substrate and having a high aspect ratio. In some embodiments, the structural elements may include one or more metal catalysts. In some embodiments, the structural elements may include multiple metal catalysts in a patterned configuration, such as for example, in a periodic arrangement of alternating layers that are horizontally aligned.

In an illustrative embodiment, an apparatus for producing carbon-containing molecules is provided. The apparatus includes a nanostructure adapted to catalyze a light-initiated reaction between water and a carbon-containing source that results in a molecule having at least two carbon atoms chained together.

In another illustrative embodiment, a method of forming a carbon-containing molecule is provided. The method includes contacting a nanostructure with water and a carbon-containing source; and exposing the nanostructure to light to initiate a reaction between the water and the carbon-containing source to form a molecule having at least two carbon atoms chained together.

In a further illustrative embodiment, a method of manufacturing an apparatus for producing a carbon-containing molecule is provided. The method includes forming a nanostructure bonded to a substrate, the nanostructure adapted to catalyze a light-initiated reaction between water and a carbon-containing source that results in a molecule having at least two carbon atoms chained together.

In another illustrative embodiment, a system for producing long chain molecules is provided. The system includes a chamber containing water and a carbon-containing source; and a nanostructure disposed within the chamber and in contact with the water and the carbon-containing source, the nanostructure adapted to catalyze a light-initiated reaction between the water and carbon-containing source in the chamber to result in a molecule having at least two carbon atoms chained together.

The foregoing is a non-limiting summary of the invention, which is defined by the attached claims. Other aspects, embodiments, features will become apparent from the following description.

### BRIEF DESCRIPTION OF DRAWINGS

The accompanying drawings are not intended to be drawn to scale. In the drawings, each identical or nearly identical component that is illustrated in various figures is represented by a like descriptor. For purposes of clarity, not every component may be labeled in every drawing.

The advantages and features of this invention will be more clearly appreciated from the following detailed description, when taken in conjunction with the accompanying drawings.

FIGS. 1A-1C show electron micrographs of nanostructures in accordance with various embodiments;

FIG. 2A illustrates a section view schematic of a nanostructure in accordance with some embodiments;

FIG. 2B depicts a section view schematic of the nanostructure of FIG. 2A exposed to radiation;

FIG. 3A illustrates a section view schematic of another nanostructure in accordance with some embodiments;

FIG. 3B depicts a section view schematic of the nanostructure of FIG. 3A exposed to radiation; FIG. 4 depicts a schematic and an optical micrograph of a system having a nanostructure according to an illustrative embodiment;

FIG. 5A shows a schematic of a system having a nanostructure subject to irradiation in accordance with some embodiments;

FIG. 5B shows a schematic of another system having a nanostructure subject to irradiation in accordance with some embodiments;

FIG. 6 illustrates a schematic section view of a nanostructure in accordance with some embodiments;

FIG. 7 illustrates a schematic section view of two layers of a nanostructure in accordance with some embodiments; FIG. 8 depicts a graph showing resonance wavelengths corresponding to different layers of a nanostructure and in accordance with some embodiments;

FIGS. 9A-9G illustrate a process for forming a nanostructure in accordance with some embodiments;

FIGS. 10A-10B show measured results of an example process for forming carbon-containing molecules; and

FIG. 11 depicts measured results of an example process for forming carbon-containing molecules.

### DETAILED DESCRIPTION

Aspects discussed herein relate to the use of an apparatus having nanostructural features for producing long chain carbon-containing molecules (e.g., hydrocarbons, amino acids, polymers) from water and a carbon-containing source typically having a single carbon atom (e.g., carbon dioxide, bicarbonate, methane). In some embodiments, a nanostructure having one or more structural elements is bound to a substrate and is placed in contact with water and a suitable carbon-containing source. When the nanostructure is irradiated with light, a reaction between the water and carbon-containing source is catalyzed by the nanostructure and a molecule having at least two carbon atoms chained together is formed. In an embodiment, nitrogen is in contact with the nanostructure along with water and the carbon-containing source such that when the nanostructure is irradiated with light, amino acids are formed.

Accordingly, nanostructures and methods for their use may allow for the ability to produce renewable energy in the form of carbon-containing molecules having at least two carbon atoms chained together (e.g., long chained hydrocarbons). Because such sources of energy is so easily renewed, existing energy resources (e.g., fossil fuels, coal, nuclear energy, etc.) may be more efficient utilized and conserved.

In some embodiments, a suitable nanostructure is fabricated using methods involving a femtosecond laser where the focused laser beam causes formation of an array of nano-spike structures from a metal precursor, the method being discussed further below. The combination of the structure and the metal of the nanostructure serves as a catalyzing agent that allows for long chained carbon-containing molecules to be formed in the presence of light energy, water and the carbon-containing source. The inventors have appreciated that such a reaction, given the reactants and products, is similar to that which occurs in photosynthesis, which is a chemical process that uses light energy to convert carbon dioxide, as a carbon-containing source, into organic compounds typically having several carbon atoms chained together. As such, methods and apparatuses described herein are contemplated to be useful as a form of artificial photosynthesis and in providing a valuable source of renewable energy.

A single nanostructural apparatus may be used to perform photosynthesis efficiently and effectively, serving to initiate catalytic processes including photodissociation. For example, water, carbon dioxide and nitrogen molecules can be photodissociated around and in proximity to nanostructural surfaces of a suitable nanostructure. In some embodiments, nanostructures have one or more structural elements that each have a tip with a diameter on the order of a few nanometers. The tip of each structural element in the nanostructure is able to focus light shined on to the nanostructure as a light concentrator in the region where the tip is located. For example, upon exposure to light radiation, a nanostructured metal surface may enhance the irradiated light to an intensity of more than 10,000 times that of initial incidence. Such focused light may function to dissociate molecules through single photon and/or multiple-photon processes. As discussed further below, structural elements of a nanostructure may have other features that assist in focusing exposed light so as to enhance the process of artificial photosynthesis.

In some cases, suitable structural elements of nanostructures are able to focus light in a manner that functions as a nano-optical lens having photodissociation possessing properties. Such properties may also be useful for surface enhanced Raman spectroscopy (SERS) involving enhanced Raman scattering by molecules adsorbed on rough metal surfaces.

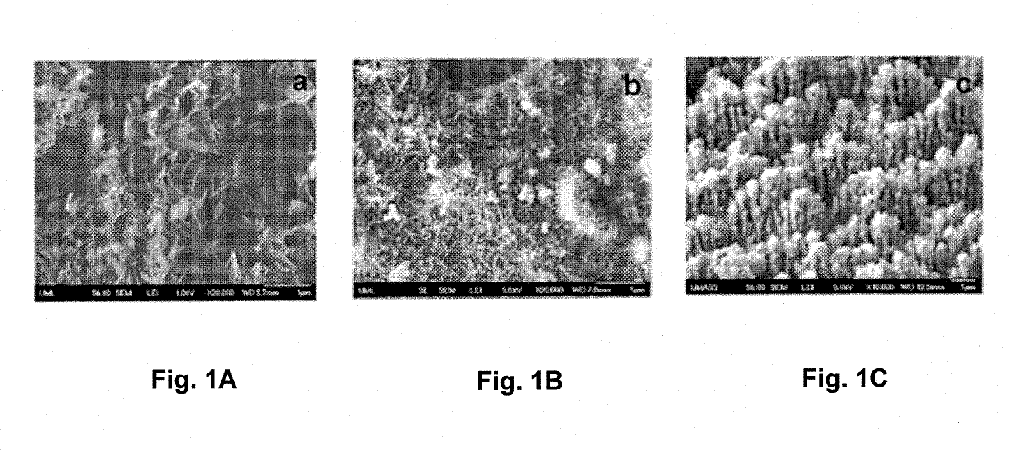

In some embodiments, nanostructures may be formed as an array of high aspect ratio structural elements. In some instances, as shown in FIG. 1A-1C, nanostructures take on a nanoforest, nanograss and/or nanoflake configuration. FIGS. 1A-1C depict scanning electron microscope images of an illustrative embodiment of a nanostructure having structural elements of cobalt microparticles disposed on an iron substrate. FIG. 1A shows the formation of cobalt nanoflakes after a femtosecond laser irradiation of cobalt powder in water at a fluence of 5 kJ/m² per pulse. FIG. 1B depicts the formation of cobalt nanograss fabricated with the same femtosecond laser system at a fluence of 1 kJ/m² per pulse. FIG. 1C illustrates the formation of a cobalt nanoforest on an iron substrate fabricated using a femtosecond laser at a fluence of 5 kJ/m² per pulse.

Nanostructures described and the structural elements that make up the nanostructures may have any suitable geometry and dimensions. For example, structural elements of a nanostructure may have a spike or grass-like geometry. Or, structural elements of nanostructures may have a flake-like geometry having a relatively thin thickness. In some embodiments, structural elements of nanostructures bound on a substrate have an average height of less than 5 microns, or less than 3 microns. In some embodiments, structural elements of nanostructures bound on a substrate have an average height of greater than 100 nm, greater than 500 nm, or greater than 1 micron. Structural elements of nanostructures may have any suitable thickness, for example, less than 1 micron, less than 500 nm, less than 200 nm, or less than 100 nm in thickness.

As discussed previously, structural elements of suitable nanostructures may have a relatively high aspect ratio (i.e., height to thickness ratio), as some structural elements may be formed as nano-spikes, nano-flakes or nano-needles. In some embodiments, the aspect ratio of a structural element may be between about 1 and about 20, between about 1 and about 10, or between about 2 and about 8.

As discussed, nanostructures having one or more structural elements may be bound to a substrate. Accordingly, structural elements of nanostructures are generally not aggregated together, but rather, pack in an orderly fashion. FIG. 1C depicts an example of a packing arrangement where structural elements of the nanostructure are arranged in an orderly configuration without aggregation.

In some embodiments, flakes and grass-like nanostructures are thinner than 100 nm, resulting in a generally large the surface area of the nanostructured apparatus. In some cases, nanostructured surfaces formed with high intensity femtosecond laser irradiation are able to tolerate high photodissociation light intensities around the nanostructures without incurring damage to the structural elements or the substrate.

Structural elements of nanostructures described may have any suitable composition. In some embodiments, nanostructures include one or more metals. Suitable metals incorporated in a nanostructure may include, but are not limited to, Co, Fe, Ni, Ti, stainless steel, and/or alloys thereof. In some embodiments, a nanostructure having suitable characteristics and dimensions in accordance with the present disclosure may be formed of a polymeric material (e.g., polyimide, PTFE, polyester, polyethylene, polypropylene, polystyrene, polyacrylonitrile, etc.). Where a nanostructure includes a metal and a polymer, in some cases, structural elements made up of the polymer are coated with a metallic material. Or alternatively, structural elements made up of a metal may be coated with the polymer. In some embodiments, a metal oxide (e.g., cobalt oxide, iron oxide, nickel oxide, titanium oxide, etc.) is incorporated in structural elements of the nanostructure and may be provided as a coating to a metal portion. In some cases, neither a metal nor a metal oxide are incorporated in a nanostructure and the structural elements that make up the nanostructure.

In various embodiments, a structural element may be formed in a manner that exposes a suitable metal so as to result in effective catalysis of reactions for producing carbon-carbon bonds and the formation of long chain carbon-containing molecules. For example, cobalt and iron are contemplated as non-limiting materials for use in structural elements of nanostructures that are able to catalyze reactions such as hydrocarbon synthesis from carbon monoxide and hydrogen. Accordingly, structural elements of appropriate nanostructures may include cobalt, iron or any other suitable material that provides a catalyzing agent for artificial photosynthetic reactions when water and a carbon-containing source are irradiated with light under suitable conditions.

Nanostructures of the present disclosure having one or more structural elements may be formed by any suitable method. In some embodiments, a suitable nanostructure is formed by the application of a pulsed femtosecond laser for inducing self-assembly of the nanostructure. For example, cobalt or iron nanostructures may be formed by applying femtosecond laser irradiations to the surfaces of a cobalt or iron pre-cursor. Pulsed laser-assisted etching may be a useful method for fabricating small regular structural features directly on a solid surface. In some instances, such a fabrication method can be orders of magnitude faster than chemical or ion beam etchings. For example, a Ti:sapphire femtosecond laser may be suitable for fabricating nanostructures and respective structural elements. Laser irradiations for forming nanostructures discussed herein may exhibit energy levels of between about 1 kJ/m² and about 5 kJ/m², though are not limited as such. For example, suitable nanostructures may be formed with laser irradiations having different energy levels, or without laser irradiation at all. As such, suitable nanostructures in accordance with the present disclosure are not required to be formed by laser irradiation.

Indeed, suitable nanostructures may be formed by any appropriate method, such as for example, chemical etching and/or electroplating.

In some embodiments, a femtosecond laser may be applied to irradiate a metal powder dispersion in a solvent, for example, cobalt or iron microparticles dispersed in water. In some cases, the femtosecond laser may be applied to emit a beam having a wavelength between about 500 nm and about 1 micron (e.g., 800 nm). In some embodiments, during irradiation, the femtosecond laser may exhibit a pulse duration of between about 50 femtoseconds and about 200 femtoseconds (e.g., 100 femtoseconds). Due to the femtosecond irradiation, the metal powder dispersion may self-assemble into an organized array of high aspect ratio nanostructural elements. For example, in an embodiment, a femtosecond laser is applied at a wavelength of 800 nm with a pulse duration of about 100 femtoseconds to irradiate cobalt microparticle powders dispersed in water. Such a laser irradiation results in a transformation of the surfaces of the cobalt microparticles into nanometer-sized flakes or nanometer-sized grasses. Examples of nanostructures formed via application of a femtosecond laser are shown in FIGS. 1A and 1B.

As discussed above, for some embodiments, forming a nanostructure that is used to catalyze reactions for producing a long chained molecule (e.g., hydrocarbon, amino acid, etc.) may include initially providing a metal powder as a pre-cursor (e.g., metal microparticles dispersed in a solvent) to the nanostructure. In some cases, such a metal powder may have an average width (e.g., diameter) of between about 10 microns and about 500 microns, between about 50 microns and about 200 microns (e.g., about 100 microns). In some embodiments, a metal may be provided as a pre-cursor in a form other than a powder, such as a network or solution.

Any suitable metal may be used as a pre-cursor to the nanostructure, such as Co, Ag, Cu, Fe, Ni, Ti, stainless steel and/or a combination thereof. Pre-cursors having multiple metals may be provided as a mixture or an alloy. In some cases, Co mixed with one or more metals may serve to augment catalysis and ultimately enhance the process of photosynthesis. For instance, appropriately applied radiation from a femtosecond laser may interact with Fe, Cu, Ti, Ni, or Ag metals mixed with Co to form a suitable nanostructure. Other catalyzing materials may be used in forming the nanostructure. In some embodiments, the nanostructure does not require the incorporation of cobalt to function as a suitable catalyst.

In forming nanostructures that enable initiation of reactions leading to the production of long chained molecules, for some embodiments, metal pre-cursors (e.g., metal powders) are melted into a semi-liquid state prior to formation of the nanostructures. For instance, irradiation by the femtosecond laser may cause a metal pre-cursor to coalesce into a semi-liquid state. The semi-liquid metal may subsequently self-assemble into high aspect ratio nanostructural elements.

An appropriate nanostructure may be included in an apparatus to suitably catalyze reactions that lead to the formation of organic molecules. Such an apparatus may include, at least, a suitable nanostructure, water, a carbon-containing source and a source of light irradiation. In some embodiments, the apparatus includes a chamber that contains the nanostructure, water and the carbon-containing source.

Any suitable carbon-containing source may be used in a reaction with water catalyzed by the nanostructure to form larger organic molecules. In some embodiments, the carbon-containing source may be carbon dioxide. In some embodiments, the carbon-containing source may be bicarbonate and/or methane. The carbon-containing source may be a mixture of carbon dioxide, bicarbonate, and methane or may include a molecule other than carbon dioxide, bicarbonate, or methane. In some embodiments, carbon dioxide, bicarbonate, and methane are absent from the carbon-containing source. In cases where methane is provided in the carbon-containing source, in some instances, the methane is transferred to a liquid fuel, greatly decreasing the overall cost of methane gas transportation. Further, any suitable concentration of bicarbonate may be used.

In some embodiments, the apparatus includes nitrogen as a reactant along with the water and the carbon-containing source. Accordingly, light irradiation on a suitable nanostructure may initiate a reaction that produces nitrogen-containing molecules, such as amino acids.

Long chained organic molecules can be formed by any suitable method. In some embodiments, an appropriate nanostructure having a number of structural elements (e.g., array of nanostructured spikes) is disposed in a chamber and in contact with water and a carbon-containing source such as carbon dioxide. The nanostructure and the starting materials (e.g., water and carbon dioxide) are irradiated to initiate a reaction between the starting materials to form an organic molecule having at least two carbon atoms chained together. Irradiation may include any appropriate energy derived from electromagnetic waves. For example, the nanostructure may be irradiated by shining natural light into the chamber. Artificially generated light may also be sufficient to initiate a suitable reaction. In some embodiments, appropriate radiation (e.g., electromagnetic light, visible light) involves focusing the light waves on to portions of the nanostructure disposed within the chamber. For example, the light may be focused on to certain regions of structural elements (e.g., nano-needle tips) where the light can be further concentrated so as to enhance carbon-carbon bonding.

In cases where long chain hydrocarbons are produced, reactions for forming hydrocarbons may involve dissociating carbon dioxide into carbon monoxide and oxygen, dissociating water into hydrogen and oxygen, and then synthesizing hydrocarbons from the hydrogen and carbon monoxide. Such photodissociation processes are shown by equations (1) and (2) below:

H₂O+photons →H₂+½ O₂, (1)

CO₂+photons→CO+½ O₂. (2)

In an embodiment, water and nanostructured Co microparticles are sealed in a glass chamber and, to induce photodissociation, the chamber is irradiated with sunlight. For example, an artificial light source may be used to simulate sunlight at air mass (AM) 1.5 100 mW/cm² to irradiate the nanostructured Co microparticles in the sealed chamber while in a room temperature environment. Such irradiation may give rise to the formation of hydrogen and carbon monoxide in the chamber. In some embodiments, no thermal or electrolysis effects are involved in the reaction, as no electric circuit elements are provided on or in close proximity to the nanostructures.

A metal nanostructure surface (e.g., Co nanostructure) may enhance photodissociation for the synthesis of hydrocarbons. In some instances, hydrogen atoms and the carbon monoxide molecules formed in the photodissociation process coexist around the metal surface. Accordingly, the hydrogen atoms and carbon monoxide molecules may form various hydrocarbons on the metal catalytic surfaces.

In an example, hydrocarbon synthesis using Co nanostructures is described. A dispersion of nanostructured Co microparticle powder and distilled water is placed on the bottom of a glass chamber. After removing the air in the chamber, the chamber is filled with carbon dioxide and the chamber is sealed. A light source is used to simulate sunlight at AM 1.5 100 mW/cm² to irradiate the nanostructured Co microparticles in the sealed chamber while in a room temperature environment. After several hours of irradiation, the water becomes brown and turbid, and a layer of an oil or a wax-like substance accumulates on the surface of the water. After irradiation, alcohol compounds may be present in the water. In addition, after irradiation, various kinds of hydrocarbons and carbohydrates may be synthesized and found accumulated in the oil or wax-like layer, including alkanes, olefins, carbon ringed structures, alcohols and branched paraffins.

In some embodiments, liquid and solid hydrocarbons are produced at a rate of about 50 mL/(gh) on the nanostructured cobalt microparticles. It should be appreciated that the rate of long chain molecule formation is not limited to particular rates described herein.

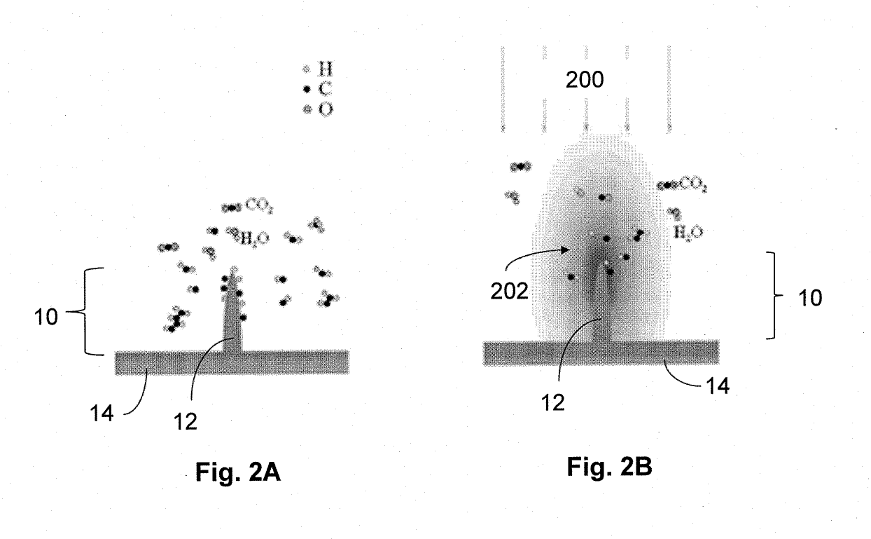

FIGS. 2A-2B depict a schematic of an illustrative embodiment of an artificial photosynthesis process. A nanostructure 10 (e.g., cobalt nanostructure) includes a structural element 12 (e.g., nano-spike) having a high aspect ratio attached to an underlying substrate 14. As illustrated in FIG. 2B, light 200 that is incident on the nanostructure focuses in such a manner that the light becomes concentrated around and in the immediate vicinity 202 of the nanostructure. Water and carbon dioxide molecules are photodissociated on the surface of the structural element 14. After the light irradiation ceases, the photodissociated molecules remain on the surface of the structural element and efficiently form hydrocarbon molecules. In some embodiments, surface-enhanced photodissociated molecules are predominantly located at the surface of the nanostructured surface and, hence, are able to form longer chain molecules than, for example, water and carbon dioxide having been dissociated through the photovoltaic effect and electrolysis which may not result in dissociated molecules located in a high concentration at a catalytic surface. While not expressly shown in FIGS. 2A-2B, it can be appreciated that nanostructure 10 may include more than one structural element 12.

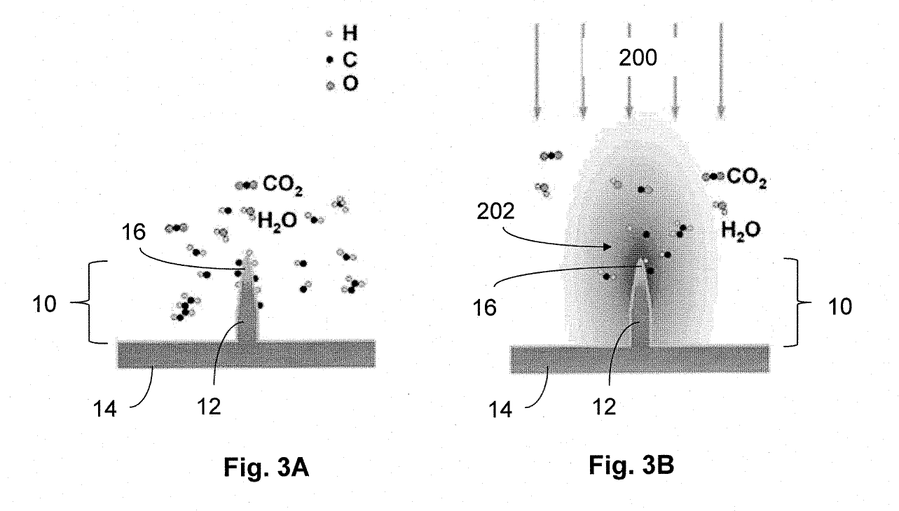

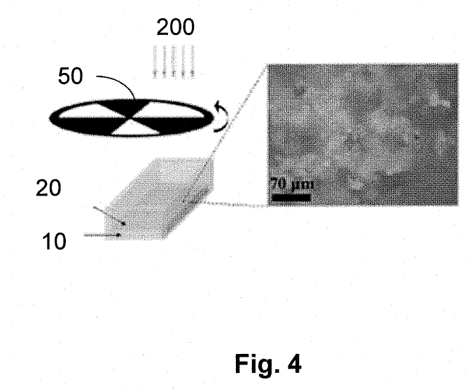

In some embodiments, a thin oxide layer covers the structural element of the nanostructure. For example, upon suitable formation of a high aspect ratio metal nanostructure with a femtosecond laser, a metal oxide layer (e.g., cobalt oxide) is also formed over the underlying metal nanostructure. FIG. 3A shows a nanostructure 10 where a high aspect ratio structural element 12 is formed on a substrate 14. During the course of formation of the nanostructured system, a metal oxide layer 16 is formed over the high aspect ratio structural element 12. The metal oxide layer may have any suitable thickness. In some embodiments, the metal oxide layer has a thickness of less than about 10 nm, less than about 5 nm, or in some cases, between about 1 nm and about 2 nm.

As shown in FIG. 3B, when light 200 is incident on the nanostructured system 10, in some cases, the incident light may become intensified in the vicinity 202 around the high aspect ratio structural elements and the thin layer of metal oxide, reaching a relatively high local temperature. In some cases, the oxide (e.g., metal oxide) layer may serve as a protective layer for the high aspect ratio structural element. In some cases, the oxide may act as a photo sensitizer and/or a catalyst. In an embodiment, molecules of water and the carbon-containing source (e.g., carbon dioxide) are photo-dissociated on to the nanostructured surface, remaining on or in close proximity to the nanostructured surface so as to form hydrocarbon molecules. Nanostructure 10 may include one or more structural elements 12.

FIG. 4 illustrates a schematic embodiment of an experimental setup for initiating an artificial photosynthesis reaction. Light 200 is irradiated to nanostructured cobalt microparticles dispersed in 10 inches of water 20 and carbon dioxide while sealed in a glass chamber. On the surface of the water forms a thin layer of oil-like or a wax-like substance. An optical microscopic image of the oil-like or wax-like substance is shown on the right side of FIG. 4. Results of an experiment where a cobalt nanostructure was exposed to continuous and intermittent sunlight are presented below in the examples section.

In some embodiments, the efficiency of storing light energy in products arising from the artificial photosynthesis processes described herein is between about 5% and about 20% (e.g., about 10%). However, any suitable efficiency may be achieved using systems and methods described herein. Efficiency may be determined by comparing the energy stored in the molecules produced with the energy from the level of irradiation exposure. In some cases, liquid and solid hydrocarbon compounds are synthesized from carbon dioxide, water and sunlight at a production rate of more than 5,000 uL/(gh), more than 10,000 uL/(gh), or more than 20,000 uL/(gh). Since conditions for artificial photosynthesis are relatively straight-forward to provide (e.g., sunlight, atmospheric temperature and pressure, metal nanostructure), surface-enhanced photo-disassociation and synthesis processes described herein may enable methods for large-scale production and applications of artificial photosynthesis to arise. In some embodiments, the mass production of hydrocarbons is about 10³ to about 10⁶ times greater than that of previous works.

Nanostructures produced can be stable and functional even after a substantial amount of time. For example, Co nanostructures may be stable and still functional after two months or more of repeated use.

A chamber within which a nanostructure and appropriate reactants may be contained may include characteristics that facilitate reaction of the materials to form long chained organic molecules. In some embodiments, the chamber may be constructed so that reactants are easily recycled. For example, as water evaporates during a reaction, the chamber may have a structure that facilitates condensation of the water on to walls of the chamber and further enabling the water to flow back toward nanostructure so as to be used for reaction(s) in forming organic molecules. In some embodiments, a chamber has a curved shape (e.g., round, oval) so as to easily permit the flow of dew from water and hydrocarbons back toward the nanostructure. The chamber may be made from any suitable material, such as for example, glass.

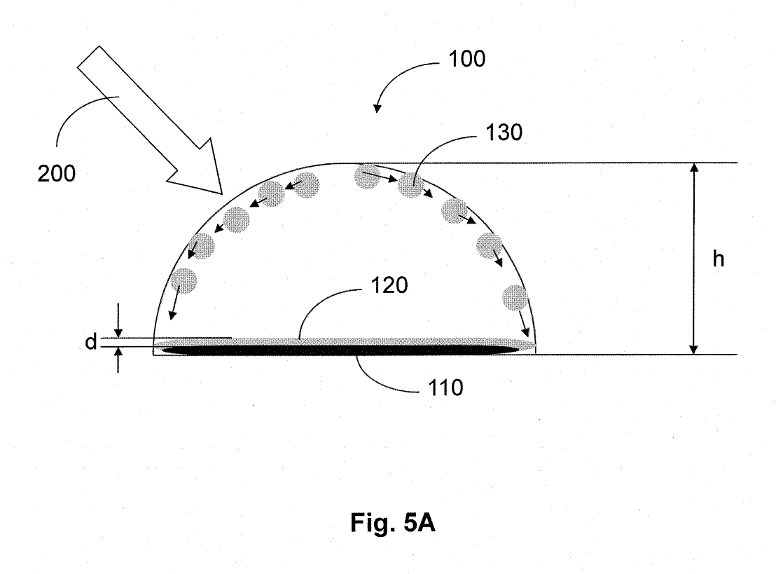

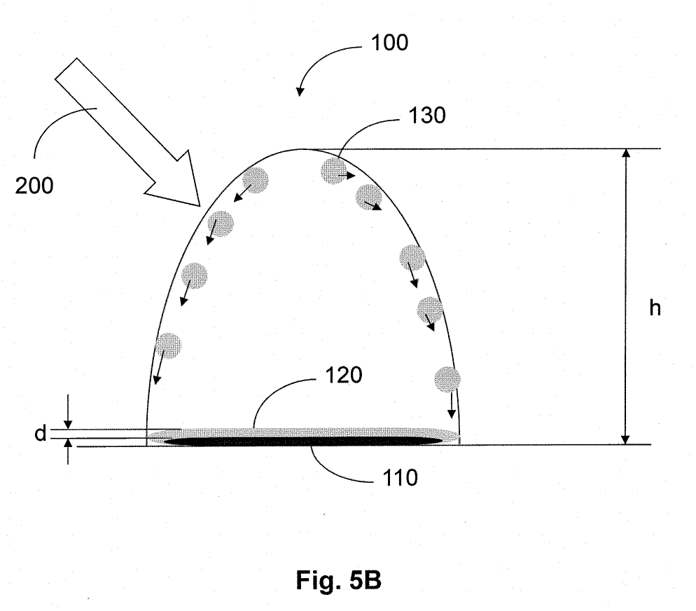

In a representative embodiment, FIG. 5A depicts a round hemispherical shaped chamber 100 surrounding a nanostructured array 110 disposed at the base of the chamber. In another representative embodiment, FIG. 5B illustrates an round half-oval shaped chamber 100 where a nanostructured array 110 is disposed at the base of the chamber. In both embodiments, the nanostructured array 110 is covered in water 120 having a depth d, for example, about 2 mm. Further, the chamber may have any suitable height h. Upon exposure to radiation 200, photodissociation reactions may be suitably catalyzed to bring about hydrocarbon production. In various embodiments, water and hydrocarbons may evaporate and condense on the surface of the chamber 100, forming droplets of dew 130. The dew 130, upon condensation, flows readily back down toward the base where the nanostructured array 110 is located. It should be appreciated that the chamber 100 should not be limited to particular shapes described, as any suitable shape may facilitate water and/or hydrocarbon condensation on a surface and flow of the water and/or hydrocarbon dew back down toward the base of the chamber. In some embodiments, the water may be placed in contact with the nanostructure to form a film having a suitable depth within a chamber. For example, the water has a depth of approximately 2 mm, or less than 2 mm within the chamber. In some cases, the water has a depth of greater than 2 mm.

The carbon-containing source may include a gas having a suitable pressure within the chamber. In some embodiments, the carbon-containing source includes carbon dioxide gas having a pressure of between about 1 atm and about 5 atm within the chamber. In some embodiments, a gas of the carbon-containing source may have a pressure within the chamber that is less than 1 atm or greater than 5 atm. Other gases may be possible besides carbon dioxide, for example, carbon monoxide or methane. In some embodiments, a system that suitably induces reactions that lead to the formation of organic molecules, includes methods for concentrating light intensity. For example, a system may include a lens to focus light irradiated on to the nanostructure. In some cases, a system includes reflectors for reflecting light back toward the nanostructure.

In some embodiments, the apparatus includes a filtration system for removing oxygen from the chamber. As oxygen is produced, the effect of its accumulation is that excess oxygen may result in a reduction of the reaction rate of water and the carbon-containing source for forming long chained organic molecules. Accordingly, it may be beneficial to provide a method for removing the oxygen as it is produced. In some embodiments, a filter or membrane system is provided (not shown in the figures) which functions to extract excess oxygen from the system.

The apparatus may also include a system for removing oils containing long chained organic molecules (e.g., alkanes, polyolefins, molecules having at least two carbons chained together, amino acids, benzene, etc.) from the base of the chamber. As oils containing long chained carbon molecules accumulate around the nanostructural elements, another filtration system may be provided for extracting this substance without affecting the remaining contents that are disposed within the chamber.

In some embodiments, the apparatus may be configured to maintain a continual supply of water or the carbon-containing source (e.g., carbon dioxide) within the chamber.

As the reactions progress, not only will the long chained organic products accumulate, but the reactants will also be used up. For example, a separate system and attachment may be provided to the chamber (not shown in the figures) where the levels of water and carbon dioxide within the chamber are monitored and automatically maintained within certain pressure levels (e.g., carbon dioxide pressure of between 1-5 atm, water depth of about 2 mm). Accordingly, the system can be configured to run continuously as reaction products are removed and reactants are replenished.

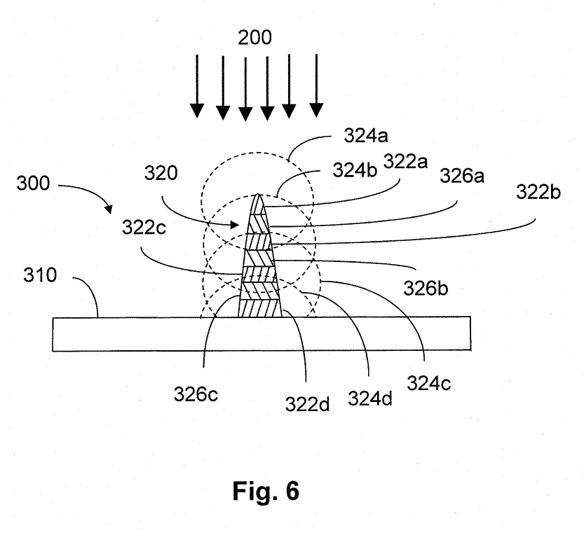

In more embodiments, a structural element of a nanostructure for use in accordance with the present disclosure may include a number of layers formed in a patterned arrangement (e.g., periodic). FIG. 6 illustrates a schematic of a nanostructure 300 attached to a substrate 310 and a structural element 320 (e.g., having a high aspect ratio such as in accordance with nano-needles, nano-flakes, nano-grass, etc.). The structural element 320 includes a number of metal layers formed in a patterned arrangement. In an embodiment, the layers of the nanostructural element are formed in a periodic arrangement of alternating radiation-focusing metal layers and catalyzing metal layers. In some embodiments, the radiation-focusing metal layer may contain one or more metals from the group including Au, Al, Ag, Cu, or combinations thereof. In some cases, certain metals such as Al may be more inexpensive than other metals, such as Au or Ag. In some embodiments, the catalyzing metal layer may contain one or more metals from the group including Co, Ag, Cu, Fe, Ni, Ti, or combinations thereof. Metal layers (e.g., radiation-focusing and catalyzing) provided in the nanostructured element may be metal alloys or mixtures. Combinations described herein may also include mixtures or alloys.

Radiation-focusing and catalyzing metal layers may alternate in a periodic configuration. In an embodiment, for instance, a first radiation-focusing metal layer 322a includes any one of Au, Al, Ag, Cu, or a combination thereof. A first catalyzing metal layer 326a including any one of Co, Ag, Cu, Fe, Ni, Ti, or a combination thereof is formed immediately adjacent to the first radiation-focusing metal layer 322a. A second radiation-focusing metal layer 322b is disposed adjacent to the first catalyzing metal layer 326a and may include any one of Au, Al, Ag, Cu, or a combination thereof. Similarly, a second catalyzing metal layer 326b may be disposed adjacent to the second radiation-focusing metal layer 322b. Such a progression may be repeated in alternating fashion along the length of the structural element. In various embodiments, radiation-focusing metal layers and catalyzing layers may be disposed in contact with one another or, alternatively, an additional layer may be disposed between a radiation-focusing metal layer and a catalyzing layer (e.g., another metal, polymer, adhesive).

Layered structural elements may provide a number of benefits. In some embodiments, the radiation-focusing metal layer of Au, Al, Ag or Cu may serve to focus or concentrate incident light around the edges of the layer adjacent to the neighboring catalyzing metal layers. This increased level of light energy may help to augment the rate and amount of reaction of water and carbon-containing source molecules (e.g., carbon dioxide, bicarbonate, methane). Accordingly, the catalyzing metal layer functions to initiate the artificial photosynthesis reaction based on the enhanced level of energy provided by neighboring radiation-focusing metal layers. For instance, Au has a plasmon resonant wavelength that focuses light radiation so as to be concentrated in its vicinity to a much greater degree than Co. Thus, the light concentrated by the Au allows for the level of reaction catalysis by Co to be enhanced. In FIG. 6, radiation-focusing metal layers 322a, 322b, 322c, 322d are arranged in an alternating configuration with catalyzing metal layers 326a, 326b, 326c. When the nanostructure is irradiated, radiation is focused in concentration regions 324a, 324b, 324c, 324d corresponding to each of the radiation-focusing metal layers 322a, 322b, 322c, 322d. When more light energy is provided in regions proximate to catalyzing metal layers 322a, 322b, 322c, 322d, reactions for producing carbon-containing molecules are augmented.

Such layered features of the nanostructural element may also reduce the general amount of oxidation that occurs in the system. For example, Au is generally resistant to oxidation and may serve as a protective material that prevents oxidation reactions from occurring in its vicinity. Accordingly, a catalyzing metal layer may be protected from oxidation by neighboring radiation-focusing metal layers. In some instances, the presence of radiation-focusing metal layers in the layered structure significantly reduces, or in some cases prevents, oxidation in the nanostructure altogether.

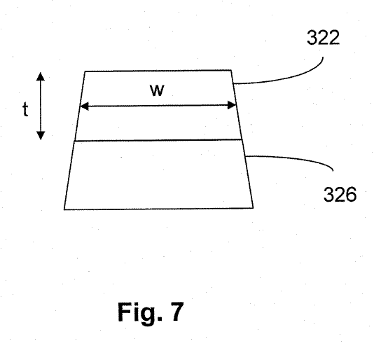

Various layers (e.g., radiation-focusing and catalyzing) of a structural element of the overall nanostructure may have suitable dimensions such as average width w and thickness t. For example, metal layers of structural elements may be formed as nano-disks having appropriate average width and thickness dimensions. FIG. 7 depicts two layers 322, 326 of a structural element of a nanostructure having an average width w and a thickness t. In some embodiments, the thickness of a layer of a structural element may be less than about 100 nm, or less than about 50 nm (e.g., having a thickness of 20 nm). In some embodiments, the average width of a layer of a structural element may be between about 5 nm and about 200 nm, or between about 10 nm and about 100 nm (e.g., having a diameter of about 10 nm or about 100 nm). In some instances, the average width w may be a diameter of a cross-section having a generally arcuate shape (e.g., having a circular or oval cross-section).

In some cases, the level at which certain wavelengths of light is absorbed may depend on the material and the dimensions of each layer. For instance, a relatively large radiation-focusing metal layer may serve to concentrate longer wavelengths of light as compared with a relatively small radiation-focusing metal layer. As an example, a radiation-focusing metal layer having a diameter of about 100 nm and a thickness greater than 20 nm may have a resonant peak at wavelengths corresponding to red or infrared radiation. That is, a larger volume radiation-focusing metal layer may have a tendency to give rise to concentrated light having a wavelength in the red or infrared regime at a greater degree than light having wavelength in the blue or ultraviolet regime.

As different sizes of structural elements of a nanostructure may correspond to different resonant wavelength peaks (e.g., plasmon resonant wavelengths), structural elements may be constructed in a configuration so as to exhibit a substantial degree of photosynthesis efficiency across a significant portion of the electromagnetic wavelength spectrum. In some embodiments, a periodic arrangement of alternating radiation-focusing metal layers and catalyzing metal layers may be suitable to concentrate light energy in proximity to and around the structural elements, resulting in efficient production of long chain carbon-containing molecules. Accordingly, the efficiency of energy production embodied in the carbon-containing molecules formed may increase due to the patterned configuration of the structural elements in the nanostructure. Such nanostructures may give rise to a photosynthesis process that is generally stable and may also exhibit longevity. It can be appreciated that other patterned arrangements of structural elements in a nanostructure may be possible. For example, while not shown, rather than having horizontally aligned layers of alternating radiation-focusing layers and catalyzing layers, a structural element of a nanostructure may exhibit vertically aligned layers of radiation-focusing layers and catalyzing layers. In another embodiment, radiation-focusing materials and catalyzing materials are not required to be formed as layers, but could simply be formed within particular regions of structural elements within a nanostructure.

FIG. 8 illustrates depicts a graph showing resonance wavelengths corresponding to different layers. Each of the radiation-focusing metal layers is constructed with a material having a set of dimensions that result in a unique resonant peak wavelength. The curves 402, 404, 406, 408, 410, 412, 414, 416, 418, 420 each illustrate the resonant peak of a corresponding radiation-focusing metal layer. Accordingly, as shown in FIG. 8, resonant peaks are present for the spectrum of light from a wavelength of 61 nm to 492 nm generally resulting in radiation having various wavelengths in this spectrum to be well absorbed. That is, the nanostructure may be configured to concentrate almost every wavelength of light in close proximity to respective catalyzing layers so as to readily initiate artificial photosynthesis reactions described herein.

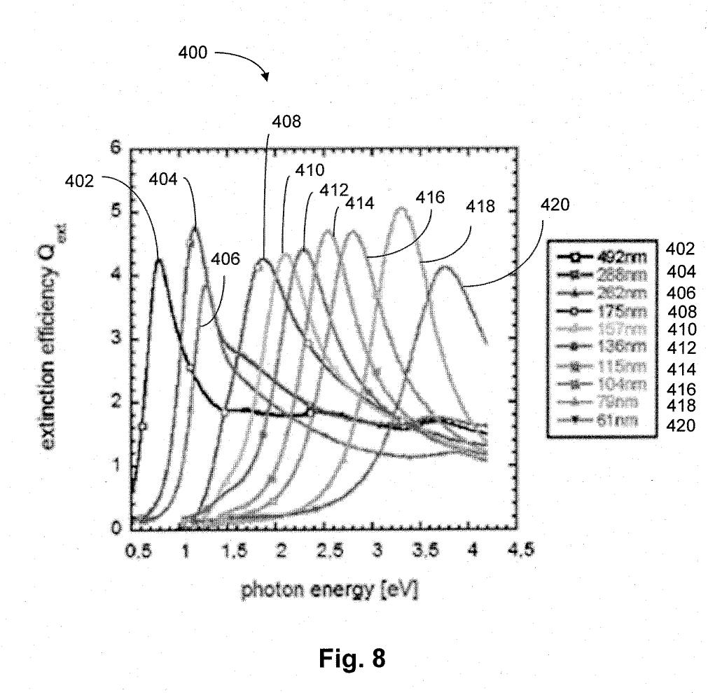

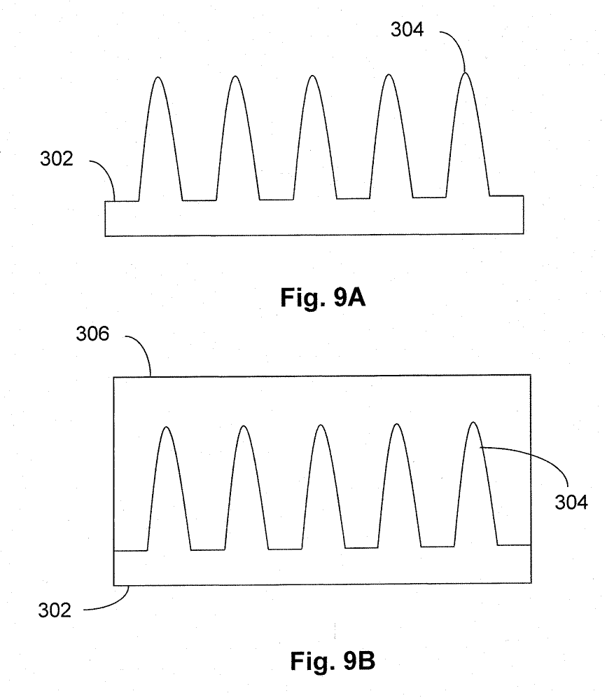

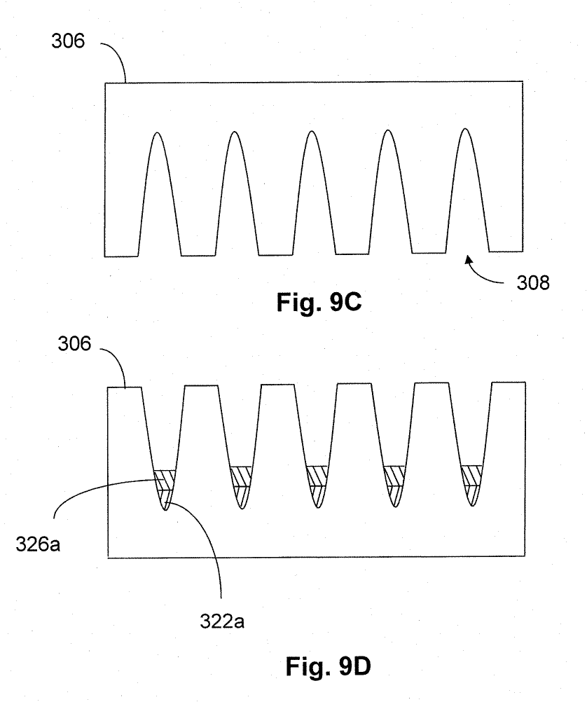

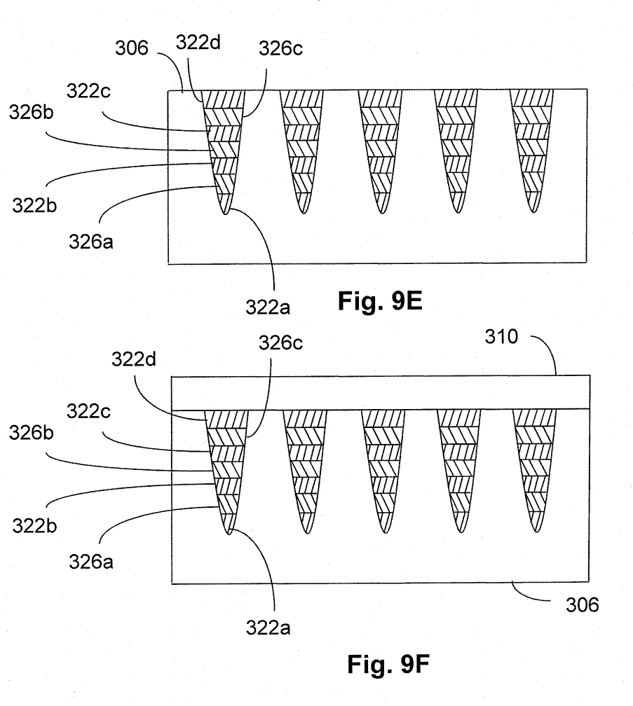

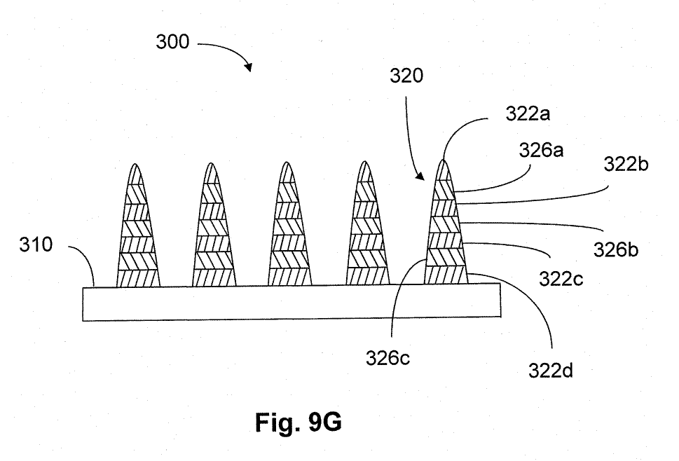

FIGS. 9A-9G depict an illustrative embodiment of a lithographic process for fabricating a nanostructure having structural elements where each structural element includes metal layers arranged in a periodic configuration. In this embodiment, a nanostructure is fabricated via femtosecond laser processes described herein, a reverse mold is made of the nanostructure, and appropriate layers of metal are subsequently deposited in the reverse mold. Accordingly, a nanostructure is formed having different layers of materials making up each of the structural elements.

As shown in FIG. 9A, a nanostructure having a first plurality of structural features 304 is formed on a substrate 302, for example, using a suitable method involving femtosecond laser irradiation as described above. For instance, the nanostructure may be formed by appropriately subjecting a dispersed mixture of metal powder (e.g., cobalt microparticles) to a femtosecond laser, giving rise to the first plurality of structural features 304 having a high aspect ratio. The shape of the nanostructure may then be duplicated with any appropriate material that can be provided via a suitable deposition processes. FIG. 9B illustrates the substrate 302 and the first plurality of structural elements 304 covered with a suitable overmold 306. Any suitable method or material for providing the overmold 306 may be used, such as through an appropriate polymerization process (e.g., application of a photoresist material).

Once the overmold is provided on the nanostructure, as illustrated in FIG. 9C, the underlying nanostructure with the first plurality of structural features 304 and the substrate 302 are removed. The structural features may be removed by any suitable method, for example, by a solvent (organic or inorganic) that dissolves the structural features, yet permits the overmold to remain without any resulting damage. As shown, a plurality of recessed structures 308 are provided in place of the plurality of structural features. Any appropriate material may be suitably deposited within the recessed structures 308. FIG. 9D depicts a stage in the initial deposition process where the overmold 306 is inverted and metal layers 322a, 326a are deposited into the recessed structures. As illustrated, a radiation-focusing metal layer 322a is deposited into a recessed structure and a catalyzing metal layer 326a is deposited on the radiation-focusing metal layer.

FIGS. 9E and 9F illustrate steps where the recessed structures are filled with appropriate layers of material and a substrate is provided so as to hole the structural elements together. FIG. 9E depicts metal layers 322a, 326a, 322b, 326b, 322c, 326c, 322d disposed in the recessed structure in successive fashion. In this embodiment, alternating radiation-focusing metal layers 322a, 322b, 322c, 322d and catalyzing metal layers 326a, 326b, 326c are arranged in a periodic configuration. As a result, upon exposure of light radiation to the nanostructure, light may be suitably focused at particular regions in a manner where reactions between water and the carbon-containing source may be enhanced. As shown in FIG. 9F, a substrate 310 is provided so as to hold the plurality of structural elements together once the overmold 306 is removed. The substrate may be any suitable material, for example, a metal that is able to form a suitable attachment with the structural elements.

Layers (e.g., metal layers) of structural elements in a nanostructure may be formed by any suitable method. In some embodiments, metal layers are provided through thin layer deposition of one layer after another, such as through evaporation, sputtering, or another appropriate method of deposition. In other embodiments, metal layers are formed within the recessed structures via a suitable chemical plating method so as to fabricate structural elements. The aspect ratio of structural elements may be increased even more than that provided by the overmold template of the initial nanostructure formed by application of the femtosecond laser. For instance, while not shown in the figures, openings may be drilled into the ends of the recessed structures, forming an even deeper recess. In some embodiments, an electron beam may be employed to increase the depth of the recessed structures where a suitable pattern of metal layers can be subsequently formed within the recessed structures. The overmold 306 may be removed by any suitable method. In some embodiments, the overmold is a photoresist that is removed through radiation of an appropriate wavelength and intensity of light. In other embodiments, the overmold may be removed by a suitable solvent that dissolves the material of the overmold while allowing the second plurality of structural elements 320 to remain. FIG. 9G illustrates the nanostructure 300 including the second plurality of structural elements 320 where the second plurality of structural elements are disposed over the substrate 310. In some embodiments, the second plurality of structural elements are attached to the substrate via a suitable bond or adhesive. The nanostructure with structural elements and substrate may then be placed in a suitable chamber under conditions that give rise to artificial photosynthesis. For example, the nanostructure may be placed in contact with water and a carbon-containing source and exposed to light in a manner such that a reaction between the water and the carbon-containing source is initiated resulting in long chain carbon-containing molecules.

Benefits afforded by systems and methods described herein which use suitable nanostructures (e.g., made up of one or more metals) for producing long chain carbon-containing molecules may include: (a) efficiently storing light energy into liquid and solid compounds formed by a carbon-containing source (e.g., carbon dioxide, bicarbonate, methane, etc.) and water; (b) a spontaneous photodissociation process without the use of thermal or electrolysis effects; (c) a process suitable with water and atmospheric temperature and pressure; (d) stable and continuous functionality without the need for extra equipment; and (e) usage of sunlight as the only energy source for producing the carbon-containing molecules.

### EXAMPLES

The dynamics of artificial photosynthesis was studied as related to whether continual or intermittent sunlight was applied to a cobalt nanostructure. The system used was that shown schematically in FIG. 4 where a light chopper was rotated so as to provide cyclical irradiation to the nanostructured system at intervals of about 2 ms each. The nanostructured system including the chopper was irradiated for the same amount of time as compared to a nanostructured system where the chopper was not included. For both cases, the water became brown and turbid, and various hydrocarbons with similar compositions and production rates were obtained, including olefins, alcohols, branched paraffins and alkanes. Despite the chopper blocking off the light source during half of the irradiation time, the actual production rate was increased, when using the chopper, by about 110% [about 105 mL/(gh)]. Accordingly, for some embodiments, exposing the nanostructure to intermittent light may be effective to increase the rate of reaction of water and the carbon-containing source to produce carbon molecules having at least two carbon atoms chained together.

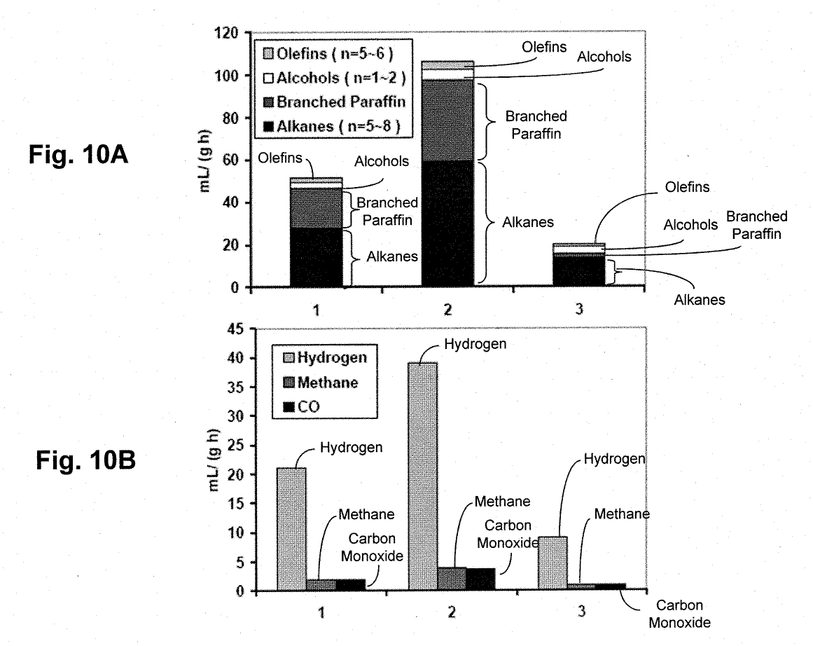

FIGS. 10A-10B illustrate relative amounts of hydrocarbons and gas that were produced from the different nanostructured systems. FIG. 10A depicts the reaction products generated from three experiments where a cobalt nanostructured array is exposed to sunlight in the presence of water and carbon dioxide. Set 1 illustrates the reaction products from a system where a cobalt nanostructure is irradiated with sunlight. Set 2 depicts the reaction products from a system where a cobalt nanostructure is subject to intermittent sunlight irradiation through use of a light chopper. Set 3 illustrates the reaction products recorded from a system where an iron nanostructure is irradiated with sunlight. The “n” shown in FIG. 10A is to denote the number of carbon atoms in a molecule. FIG. 10A refers to the hydrocarbon and carbohydrate products that were detected in liquid and solid states. As shown, a combination of olefins, alcohols, branched paraffins and alkanes were detected from the light-initiated reactions catalyzed by the Co nanostructure. The amount of long chained organic molecules produced from the nanostructured array where a chopper was included within the experimental setup was observed to be greater, almost double, than that of the same system having the nanostructured array and where the chopper was not included.

FIG. 10B shows the amount of gas products detected from the reactions after sunlight irradiation, recording hydrogen, carbon monoxide and methane. Also shown in FIG. 10B, a generally low production rate of 2 mL/(gh) of methane may occur in the gas phase.

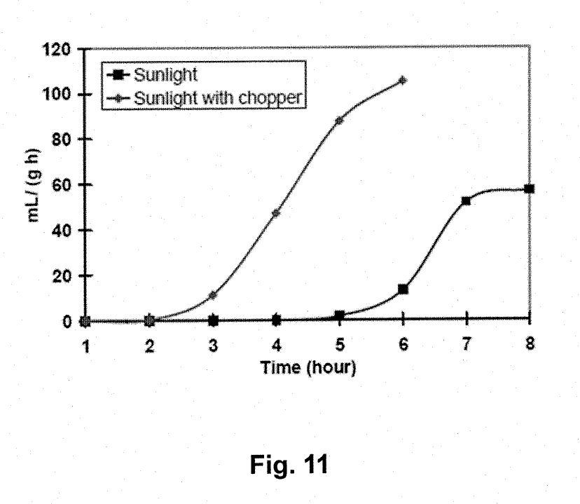

In addition, the amount of hydrocarbons produced over time was measured comparing nanostructured systems that were exposed to intermittent sunlight (with a chopper) and nanostructured systems that were exposed to continuous sunlight (without a chopper). FIG. 11 shows an embodiment of data recording hydrocarbon production rates where, in some cases, an irradiation time threshold may exist for hydrocarbons to be formed.

Such a threshold may be caused by a minimum dissociated molecule concentration for the synthesis reaction. In some embodiments, adding a chopper can lower the time threshold as compared to not having a chopper using the same light source. As shown, for the case where the nanostructured array was exposed to continuous sunlight, the production of long chain carbon-containing molecules (artificial photosynthesis) began to occur at about 4.5 hours. For the case where the nanostructured array was exposed to intermittent sunlight, the production of long chain carbon-containing molecules began to occur at about 2 hours. FIG. 11 also illustrates irradiation time dependencies of the formation of hydrocarbons and carbohydrates for some embodiments using cobalt nanostructured arrays irradiated with continuous sunlight and intermittent sunlight.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only. It will be apparent that other embodiments and various modifications may be made to the present invention without departing from the scope thereof. The foregoing description of the invention is intended merely to be illustrative and not restrictive thereof. The scope of the present invention is defined by the appended claims and equivalents thereto.

What is claimed is:

1-20. (canceled)

21. A method of forming a carbon-containing molecule, the method comprising:
contacting a nanostructure with a hydrogen-containing source and a carbon-containing source molecule; and
exposing the nanostructure to light to initiate a reaction between the hydrogen-containing source and the carbon-containing source molecule to form a product molecule having at least two carbon atoms chained together, wherein the carbon-containing source molecule has fewer carbon atoms than the product molecule.

22. The method of claim 21, wherein the hydrogen-containing source and the carbon-containing source molecule are disposed within a chamber, the hydrogen-containing source having a depth of less than about 2 mm within the chamber and the carbon-containing source molecule being a gas having a pressure of between about 1 atm and about 5 atm within the chamber.

23. The method of claim 21, wherein exposing the nanostructure to light includes irradiating the nanostructure with solar light.

24. The method of claim 21, wherein exposing the nanostructure to light to form a product molecule having at least two carbon atoms chained together comprises producing a molecule having an energy that is at least 10% that of an initial energy of the light exposure.

25. The method of claim 21, wherein exposing the nanostructure to light to form a product molecule having at least two carbon atoms chained together comprises forming a hydrocarbon, an amino acid, a polymer, a nitrogen-containing substance, an alcohol or a combination thereof.

26. The method of claim 21, wherein exposing the nanostructure to light to initiate a reaction between the hydrogen-containing source and the carbon-containing source molecule includes catalyzing the reaction between the hydrogen-containing source and the carbon-containing source molecule involving at least one metal comprising Co, Cu, Fe, Ti, Ag, or a combination thereof.

27. The method of claim 21, wherein the carbon-containing source molecule comprises at least one of carbon dioxide, bicarbonate, methane, carbon monoxide, a hydrocarbon, or a combination thereof.
